(19) United States
(12) Patent Application Publication
(10) Pub. No.: US 2020/0043249 A1
(43) Pub. Date: Feb. 6, 2020

(54) System and Method for Incentivized Vehicle Diagnostics

(71) Applicant: Robert Bosch GmbH, Stuttgart (DE)

(72) Inventors: Alison Accavitti, Clawson, MI (US); Marc Rosone, Northville, MI (US); David Kovacek, Royal Oak, MI (US)

(21) Appl. No.: 16/514,515

(22) Filed: Jul. 17, 2019

Related U.S. Application Data
(60) Provisional application No. 62/712,775, filed on Jul. 31, 2018.

(51) Int. Cl. G07C 5/00; G07C 5/08; G06Q 30/02

(52) U.S. Cl. CPC G07C 5/006; G07C 2205/02; G06Q 30/0235; G07C 5/0808

(57) ABSTRACT

A system and method for incentivized diagnostics of vehicles during repair or maintenance. Diagnostic data is collected and analyzed and one or more potential solutions, associated with an incentive are generated in response to the analysis. A favored solution is selected and presented to a user along with the associated incentive.

### TECHNICAL FIELD

This disclosure relates to vehicular maintenance and repair, and more particularly to a system and method for performing vehicle diagnostics with incentives for a user.

### BACKGROUND

In recent years, vehicles and the field of automotive maintenance have experienced rapid growth in computerized systems both within automotive vehicles and in computerized diagnostic tools. Modern vehicles may comprise computerized systems that may provide data indicating the functional state of associated components of the vehicle. These computerized systems may provide specialized codes to a technician during a vehicle diagnosis or repair, the codes assigned to a particular condition of the vehicle or a component of the vehicle. Computerized diagnostic codes may be utilized to assist a user in receiving and interpreting the diagnostic codes.

Current diagnostic tools may be limited in their ability to assist a user in the execution of a repair to the vehicle. Additionally, diagnostic tools may be limited in their ability to acquire data useful in making a diagnosis or assisting the user in a repair.

### SUMMARY

It may be desirable for a diagnostic tool to utilize data obtained during a diagnosis process to assist a user with diagnosis and repair of a vehicle or a component of the vehicle. Such diagnostic data may comprise diagnostic codes generated by a computerized component of the vehicle, measured data describing the conditions of the vehicle or the operation of the vehicle, or media data such as video or audio data depicting the observable condition or behavior of the vehicle during diagnosis or normal operation.

One aspect of this disclosure is directed to a method of utilizing a diagnostic device to assist a user in repairing a vehicle. The method may comprise obtaining diagnostic data using the diagnostic device and generating one or more recommended solutions in response to an analysis of the diagnostic data. The one or more recommended solutions may each be related to an incentive provided to the user that encourages a particular course of action to pursue the particular recommended solution. A favored solution may be selected based upon a data-driven probability analysis and both the favored solution and at least one associated incentive may be presented to the user.

Another aspect of this disclosure is directed to a vehicle diagnostic and incentive system comprising a diagnostic processor operable to generate diagnostic data indicating an operational condition of a vehicle. The system may further comprise a location sensor operable to generate location data indicating the location of the vehicle, the diagnostic processor, or the user. The system may further comprise a diagnostic-data store operable to store the diagnostic data. The system may further comprise a commerce-data store operable to store commerce data indicating a status of at least one provider of goods or services. They system may further comprise a human-machine interface operable to present diagnostic data, commerce data, or analytic results and associated incentives to the user. In some embodiments, the system may comprise a cloud-data source operable to store data received or generated by the diagnostic processor as historical data, and further operable to provide the historical data to the diagnostic processor. In some embodiments, the system may comprise multiple diagnostic processors.

The above aspects of this disclosure and other aspects will be explained in greater detail below with reference to the attached drawings.

### BRIEF DESCRIPTION OF THE DRAWINGS

FIG. 1a is a diagrammatic illustration of external features of a diagnostic device.

FIG. 1b is a diagrammatic illustration of additional features of the diagnostic device of FIG. 1a.

FIG. 2 is a diagrammatic illustration of a diagnostic and incentive system that utilizes diagnostic devices.

FIG. 3 is a diagrammatic illustration of an algorithmic state machine utilizing inputs to diagnose a vehicle and determine a favored solution associated with an incentive.

FIG. 4 is a flowchart depicted a method of diagnosing a vehicle and presenting a user with an incentive associated with the diagnosis.

FIG. 5 is an exemplary illustration of a user interface for navigating a collection of diagnostic data.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

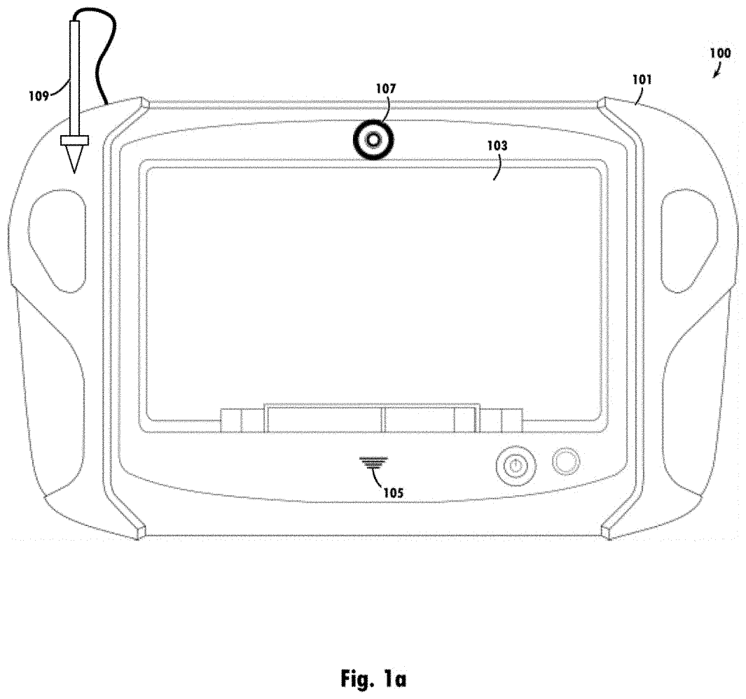

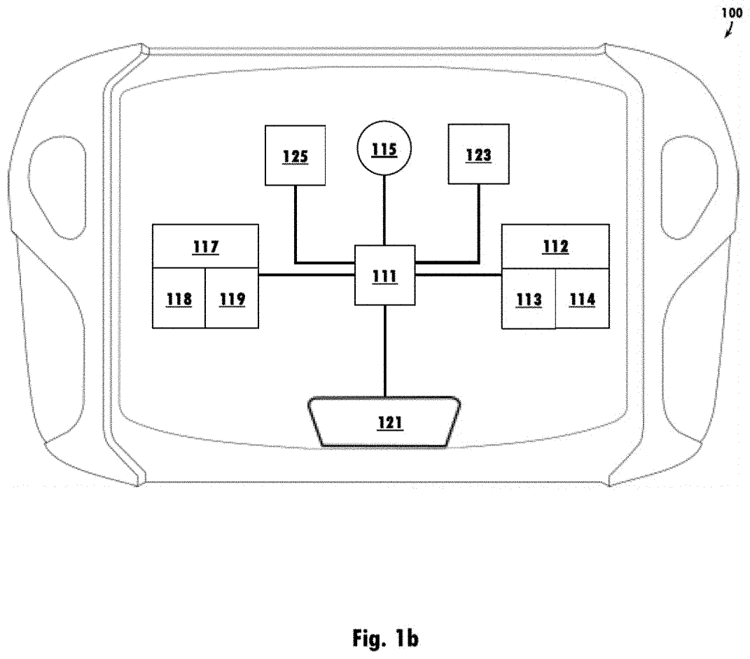

FIG. 1a shows a diagrammatic illustration of a diagnostic device 100 that may be operable to assist a user in diagnosing the operational condition of a vehicle or a component of a vehicle. In the depicted embodiment, diagnostic device 100 comprises a tablet computer device, but other embodiments may comprise a mobile processing device, a smartphone, a laptop computer, a wearable computing device, a desktop computer, a personal digital assistant (PDA) device, a handheld processor, a specialized processor, or any other alternative embodiment known to one of ordinary skill in the art without deviating from the teachings disclosed herein.

Diagnostic device 100 comprises a chassis 101 and a display 103. In the depicted embodiment, display 103 comprises a touchscreen display suitable to provide a human-machine interface to control the functions of diagnostic device 100, but other embodiments may comprise other human-machine interface components instead of or in addition to a touchscreen embodiment of display 103 without deviating from the teachings disclosed herein. In some such embodiments, a human-machine interface may comprise buttons, keys, softkeys, motion detection, verbal command, or any other input method known to one of ordinary skill in the art without deviating from the teachings disclosed herein.

Diagnostic device 100 may further comprise a number of data inputs suitable for data collection during the diagnostic process. In the depicted embodiment, diagnostic device 100 may comprise a microphone 105, camera 107, and sensor probe 109, but other embodiments may include different configurations of data collection components without deviating from the teachings disclosed herein. Some embodiments may omit one or more of microphone 105, camera 107, or sensor probe 109 without deviating from the teachings disclosed herein. Some embodiments may include a plurality of one or more of microphone 105, camera 107, or sensor probe 109 without deviating from the teachings disclosed herein. Some embodiments may include additional data collection components without deviating from the teachings disclosed herein.

Microphone 105 may be operable to record audio data corresponding to sounds of the vehicle that may be useful in determining the operational condition of a vehicle or a component of the vehicle. Sounds useful in diagnosis of the operational condition of a vehicle of a component of the vehicle may include, for example, unexpected or irregular sounds during operation of the vehicle. For example, squealing of the brakes, exhaust backfires, or irregular clunking sounds during operation of the vehicle may provide useful data in diagnosing operational condition, but any audible sounds may be useful in formulating a diagnosis of operational condition. In some embodiments, the diagnostic device 100 may be operable to diagnose conditions based upon a sound the vehicle may emit audible via a speaker that indicates a particular operating condition. A well-known, non-limiting, example of sound indicative of an operating condition is a tone audibly emitted if a vehicle's engine is deactivated but the headlights are left on. Other sounds indicative of an operating condition may also be useful in diagnosis by diagnostic device 100 without deviating from the teachings herein.

Camera 107 may be operable to record photographic or video data that may be useful in determining the operational condition of a vehicle or a component of the vehicle. Non-limiting examples of visual indications of operational conditions may include visual wear-and-tear of components, corrosion of components, damaged or missing components, abnormal behavior of components, or any other visual indication of an operating condition known to one of ordinary skill in the art without deviating from the teachings disclosed herein. Visual indications of operating condition may be evident during operation of the vehicle or during non-operation of the vehicle without deviating from the teachings disclosed herein.

Sensor probe 109 may be operable to record other data indicating operational conditions of a vehicle or a component of the vehicle. In the depicted embodiment, sensor probe 109 may be operable to measure temperature and gaseous emissions, but other embodiments may be operable to make other measurements useful in diagnosis of operational conditions, such as voltage, amperage, resistance, wattage, force, pressure, fluid velocity, or any other measurement known to one of ordinary skill in the art to be useful in diagnosing an operating condition without deviating from the teachings disclosed herein. Some embodiments may comprise a plurality of sensor probes 109, each of the sensor probes 109 being configured to make a distinct form of measurements.

FIG. 1b shows a diagrammatic view of internal components of diagnostic device 100. Diagnostic device 100 comprises a diagnostic processor 111, which is in data communication with other components diagnostic device 100. Diagnostic processor 111 may be in data communication with touchscreen 103, microphone 105, camera 107, and sensor probe 109 (see FIG. 1a).

Diagnostic processor 111 may further be in data communication with a data store 112. Data store 112 may comprise a machine-readable medium operable to store data and instructions, such as instructions that when read by diagnostic processor 111 are operable to cause diagnostic processor 111 to execute functions of the diagnostic device 100. Data store 112 may comprise other stored data useful for the operation of diagnostic device 100. In the depicted embodiment, data store 112 comprises a diagnostic-data store 113 operable to store diagnostic data pertinent to operations of diagnostic functions of diagnostic device 100. Diagnostic data may comprise data obtained from data inputs of diagnostic device 100, sensor data obtained from sensors associated with a vehicle, known conditions of a vehicle, operational symptoms associated with known conditions of a vehicle, known solutions to repair or rectify known conditions of a vehicle, data describing the correspondence of known conditions to vehicles of particular makes, models, or years, or any other data useful in determining a diagnosis of operational conditions of a vehicle or a component of a vehicle without deviating from the teachings disclosed herein. Diagnostic data may comprise diagnostic trouble codes (DTCs) generated by a diagnostic system of a vehicle pertaining to the components of the vehicle. Diagnostic data may further comprise a codex of DTCs useful for a user to decipher DTCs received by diagnostic device 100. In some embodiments, diagnostic data may further comprise data indicating user history and user preferences associated with a particular user of diagnostic device 100.

In the depicted embodiment, data store 112 comprises a commerce-data store 114 operable to store commerce data suitable for commerce-based analysis. Commerce data may comprise the status of providers of goods and services associated with vehicle maintenance and repair. Commerce data may comprise the goods or services offered by a provider, prices of goods or services offered by a provider, the business hours of a provider, the location of a provider, an inventory of goods stocked by a provider, or any other data useful to determining a solution to a diagnosis known to one of ordinary skill in the art without deviating from the teachings disclosed herein. In some embodiments, commerce data may include incentive data describing incentives provided to a user associated with a particular recommended solution. Incentives may be provided by providers of goods or services, manufacturers of goods, or third parties associated with at least one of the user, a provider of goods, a provider of services, a manufacturer of goods, or additional parties able to provide a benefit to the user of diagnostic device 100.

In some embodiments, data store 112 may comprise a single monolithic architecture storing associated diagnostic data and commerce data. In some embodiments, data store 112 may only store one of diagnostic data or commerce data without deviating from the teachings disclosed herein. In some embodiments, data store 112 may be utilized to store or receive additional data without deviating from the teachings disclosed herein.

Diagnostic device 100 may also comprise a location sensor 115 operable to generate location data indicating a location of the diagnostic device 100. In the depicted embodiment, location sensor 115 may comprise a global positioning system (GPS) sensor operable to generate GPS data, but other embodiments may comprise other configurations without deviating from the teachings disclosed herein.

Diagnostic device 100 may also comprise a network interface 117 operable to provide data communication between diagnostic processor 111 and other devices. In the depicted embodiment, data communication is accomplished using a network, such as a wireless network, but other embodiments may comprise a wired configuration, a hybrid configuration, or any other configuration known to one of ordinary skill without deviating from the teachings disclosed herein. In the depicted embodiment, network 117 comprises a transmitter 118 operable to transmit data to a network and a receiver 119 operable to receive data from a network. Other embodiments may not comprise a distinct transmitter and receiver without deviating from the teachings disclosed herein. Network interface 117 may be operable to communicate using wireless protocols such as Wi-Fi, ZigBee, Bluetooth, or any other wireless protocol known to one of ordinary skill in the art without deviating from the teachings disclosed herein. Some embodiments of diagnostic device 100 may be operable to utilize a plurality of distinct wireless protocols without deviating from the teachings disclosed herein. In some embodiments, network interface 117 may be configured to utilize wired connections without deviating from the teachings disclosed herein. In some embodiments, network interface 117 may be operable to utilize a combination of wireless and wired connections without deviating from the teachings disclosed herein.

Diagnostic device 100 may also comprise a data port 121 operable to provide data communication between diagnostic processor 111 and a vehicle during a diagnosis. In the depicted embodiment, data port 121 comprises a physical port configured to accept a hardware connection to a diagnostic port of an automobile, such as an OBD-II port. In the depicted embodiment, data port 121 is operable to communicate with a controlled area network (CAN) bus of a vehicle, but other embodiments may be configured to interface with other or additional protocols without deviating from the teachings disclosed herein. Other embodiments may comprise other configurations, such as a wireless port operable to provide data connection with a wireless component of a vehicle without deviating from the teachings disclosed herein.

Diagnostic device 100 may further comprise a human-machine interface controller 123 operable to provide data communication between diagnostic processor 111 and a human-machine interface of the device, such as touchscreen 103. Other embodiments may comprise other configurations without deviating from the teachings disclosed herein. Some embodiments may not comprise a human-machine interface controller 123, and control of any human-machine interface of the associated device may instead be performed by diagnostic processor 111 directly. In such embodiments, data store 112 may comprise operational instructions readable by diagnostic processor 111 to control the functions of the associated human-machine interface.

Diagnostic device 100 may further comprise a sensor array interface 125 operable to provide data communication between diagnostic processor 111 and the data input components of diagnostic device 100 such as microphone 105, camera 107, or sensor probe 109. Other embodiments may comprise other configurations without deviating from the teachings disclosed herein. Some embodiments may not comprise a sensor array interface 125, and control of data input components may instead be performed by diagnostic processor 111 directly. In such embodiments, data store 112 may comprise operational instructions readable by diagnostic processor 111 to control the functions of the associated data input components. In some embodiments, diagnostic device 111 may comprise a plurality of sensor array interfaces 125, each operable to provide data communication between data processor 111 and less than the totality of data input components without deviating from the teachings disclosed herein.

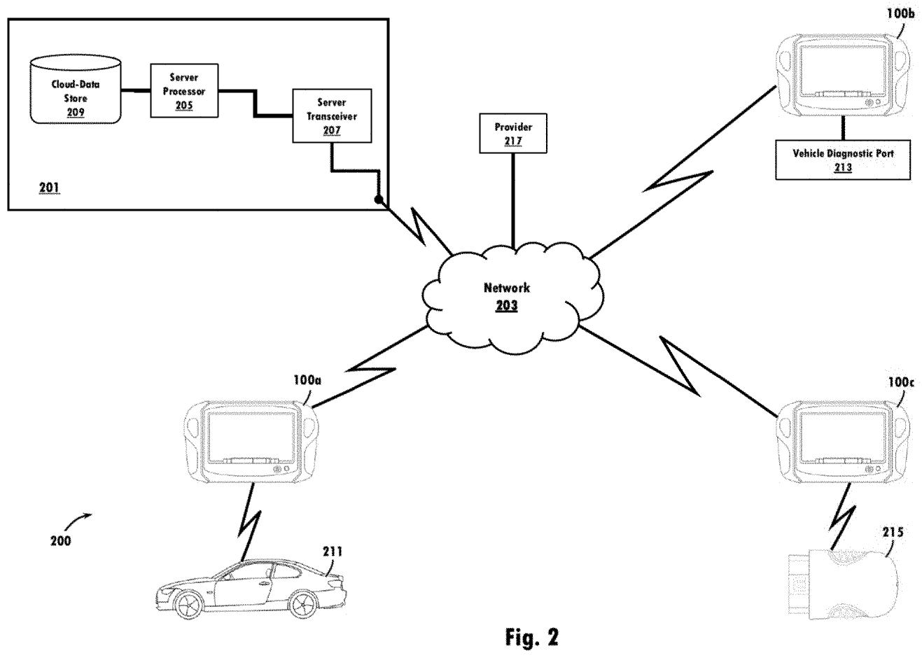

FIG. 2 is a diagrammatic illustration of a diagnostic system utilizing a number of diagnostic devices 100 (see FIG. 1). Each of diagnostic devices 100 may be in data communication with a server 201 via a network 203. In some embodiments, network 203 may additionally provide for data communication between some or all of diagnostic devices 100.

Server 201 comprises a server processor 205 in data communication with network 203 via a server transceiver 207. In some embodiments, server 201 may comprise a distinct transmitter component and receiver component without deviating from the teachings disclosed herein. In the depicted embodiment, server transceiver is configured to provide a wireless connection to network 203, but other embodiments may comprise a wired connection or a hybrid connection without deviating from the teachings disclosed herein.

Server 201 may comprise a cloud-data store 209 operable to store cloud data pertinent to diagnostic operations of the diagnosis devices 100. Cloud data may comprise diagnostic data, commerce data, or a combination of both diagnostic data and commerce data. Cloud data may be collected from each of the diagnostic devices 100 associated with network 203. Cloud data may be obtained from a third-party source without deviating from the teachings disclosed herein.

In the depicted embodiment, each of diagnostic devices 100 is in data communication with a vehicle for diagnosis utilizing a different connection. Diagnostic device 100a is in wireless communication with the diagnostic system of a subject vehicle 211. In the depicted embodiment, vehicle 211 is configured for wireless communication with diagnostic device 100a, but other embodiments may comprise other configurations without deviating from the teachings disclosed herein. Diagnostic device 100b is in wired communication with a vehicle diagnostic port 213. In the depicted embodiment, diagnostic device 100b may utilize data port 121 (see FIG. 1) to connect to the vehicle diagnostic port 213. Vehicle diagnostic port 213 may comprise an OBD-II port or any other alternative diagnostic port known to one of ordinary skill in the art without deviating from the teachings disclosed herein. Diagnostic device 100c is in wireless communication with a dongle 215 configured to interface with a vehicle diagnostic port, such as vehicle diagnostic port 213. Other embodiments of incentivized diagnostic system 200 may comprise other connectivity between a diagnostic device 100 and a vehicle subject to diagnosis.

Incentivized diagnostic system 200 additionally comprises a provider 217 operable to supply commerce data relevant to a provider of goods or services to server 201 or a diagnostic device 100. In the depicted embodiment, provider 217 is connected to network 203 using a wired connection, but other embodiments may comprise other configurations without deviating from the teachings disclosed herein. Some embodiments may comprise a plurality of providers 217 without deviating from the teachings disclosed herein. In such embodiments, each of providers 217 may supply distinct commerce data or at least partially redundant commerce data without deviating from the teachings disclosed herein.

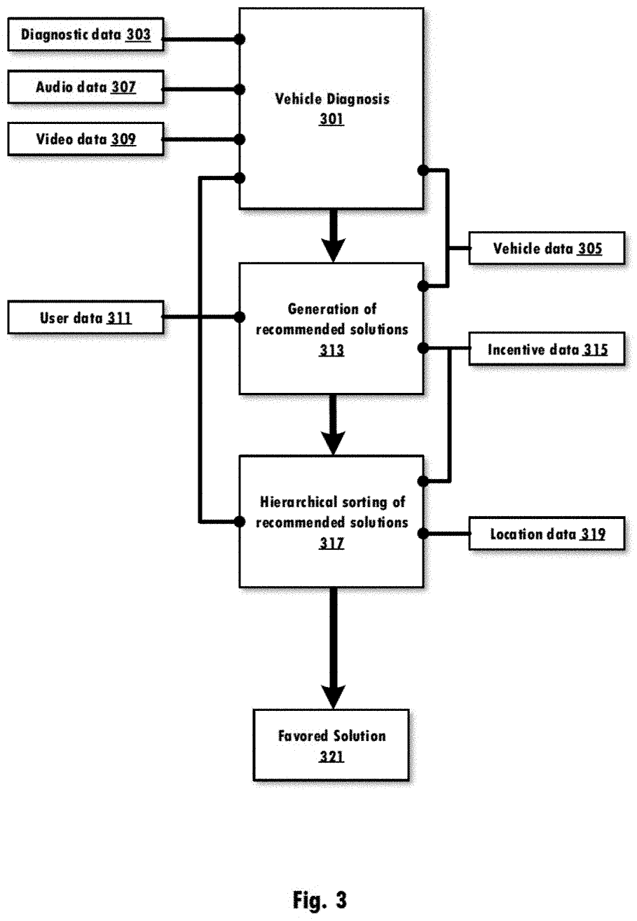

FIG. 3 is an illustration of an algorithm for determining a favored solution for presentation to a user via an incentivized diagnostic system, such as incentivized diagnostic system 200 (see FIG. 2). The algorithm begins with a vehicle diagnosis 301 which utilizes data inputs comprised of diagnostic data 303, vehicle data 305, audio data 307, video data 309, or user data 311. Diagnostic data 303 may comprise any form of diagnostic data described with respect to FIG. 1. Vehicle data 305 may indicate the make, model, year of manufacture, or mileage of an associated vehicle. Vehicle data 305 may also indicate a history of repair and maintenance for the associated vehicle. Audio data 307 and video data 309 may be collected by associated data inputs, such as microphone 105 or camera 107 (see FIG. 1). Audio data 307 and video data 309 may also comprise reference audio and reference video illustrating a particular known operating condition of a vehicle, or normal operating conditions of a vehicle. User data 311 may comprise profile information indicating information about the user useful in determining a recommended solution. Profile information may comprise an indication of a user's level of repair expertise, an indication of a user's certifications or proficiencies, a user's personal contact information, a user's current and previous locations, a user's driving behaviors, a user's history of utilizing a diagnostic device, a user's methods of making payments, a user's history of utilizing incentives, or any other data that may describe the user's relationship with a diagnostic system or a vehicle.

Vehicle diagnosis 301 may utilize at least some of diagnostic data 303, vehicle data 305, audio data 307, video data 309, and user data 311 to diagnose an operating condition of an associated vehicle. By way of example, diagnostic data 303 may comprise a DTC indicating an erroneous operating condition of the vehicle. By way of example, vehicle data 305 may indicate common problems related to the DTC for the vehicle's make and model. By way of example the audio data 307 and video data 309 obtained from data input components (see FIG. 1) may be compared to reference audio data and video data to improve probability of correlating the operating condition to a known condition. By way of example, user data 311 may indicate the user's location, which may be used to determine common needs for maintenance or repair for vehicles in that location. Other embodiments may utilize other or additional data without deviating from the teachings disclosed herein.

Once a vehicle diagnosis 301 is achieved, the algorithm then proceeds to a generation of one or more recommended solutions 313. The recommended solutions 313 indicate a way for a user to rectify the vehicle diagnosis 301, and may be associated with one or more incentives. Incentives may entice users to utilize a recommended solution 313 and engage the user with the incentivized diagnostic system.

Generation of a recommended solution 313 may utilize vehicle data 305, user data 311, and incentive data 315. Incentive data 315 may comprise incentives made available to users of an incentivized diagnostic system by providers of goods or services, manufacturers of goods, operators of the incentivized diagnostic system, user networks of the incentivized diagnostic system, or third parties offering incentives to users. Incentives may comprise monetary incentives, such as discounts or coupon offers provided by providers, manufacturers, or third parties. Incentives may comprise a rewards program utilizing loyalty points awarded to users of the system and redeemable for goods or services. Incentives may comprise access to user networks, such as online social media networks, that may provide support to the user. Incentives may comprise access to instructional media material, such as text, audio, pictorial, or video content to assist a user in rectifying vehicle diagnosis 301. Incentives may comprise product training, or real-time consultation with an expert technician to assist the user in rectifying vehicle diagnosis 301. Other incentives may be utilized instead of, or in addition to, any of the above incentives without deviating from the teachings disclosed herein. Incentives may comprise reduced-cost or expedited shipping of parts required for rectifying vehicle diagnosis 301.

In some embodiments, incentives may be dynamically adjusted to entice user engagement. By way of example, and not limitation, a coupon offering a discount for the price of needed part may dynamically diminish its discount after a window of time has elapsed from being offered to the user. In another example, for a vehicle diagnosis 301 indicating that the operating conditions of the vehicle require multiple repairs, incentives may be dynamically combined to offer multiple incentives addressing multiple operating conditions of vehicle diagnosis 301. The dynamic adjustment of the incentives may be specified by manufacturers, providers of goods or services, operators of the incentivized diagnostic system, or third parties offering the incentives. The dynamic adjustment of an incentive may be dictated by rules or limitations specified in the incentive data 315 to comply with legal requirements, or business goals of the entity offering the incentive. For example, a first manufacturer offering a first incentive in the form of a discount coupon may specify that the first incentive may not be combined with incentives offered from a competing second manufacturer. Other rules or limitations may be utilized without deviating from the teachings disclosed herein.

After a number of recommended solutions 313 have been generated, a hierarchical sorting 317 of the recommended solutions takes place. The hierarchical sorting 317 utilizes data sources to generate a number of sorting factors to form the hierarchy of the sorting. In the depicted embodiment, data sources may comprise user data 311, incentive data 315, and location data 319, but other embodiments may comprise different or additional data sources without deviating from the teachings disclosed herein. Location data 319 may comprise data indicating the location of the user, the location of the vehicle, the location of an affiliated incentivized diagnostic system, the location of a provider, or any other location-based data useful for constructing a hierarchical sorting recognized by one of ordinary skill in the art without deviating from the teachings disclosed herein.

The hierarchical sorting 317 utilizes weights defined according to a predetermined configuration in view of the data sources. The predetermined configuration may be determined by the user, a provider, a manufacturer, an associated third party, or an operator of an affiliated incentivized diagnostic system. In the depicted embodiment, a higher weight may be given to incentives that are in closer physical proximity to the user of the incentivized diagnostic system according to location data 319. In some embodiments, the user may specify a preference for incentives in particular locations according to location data 319, such as near the user's home or place of work. In some embodiments, a higher weight may be given to incentives that are similar to incentives the user has previously utilized according to the user data 311. In the depicted embodiment, a higher weight may be given to incentives that are favored by a provider, a manufacturer, a third party, or an operator of the affiliated incentivized diagnostic system. For example, a manufacturer may increase the weighting of incentives that are intended to sell an old model of a part when a new model is ready to be introduced for sale. In another example, the operator of the incentivized diagnostic system may increase the weighting of incentives that are offered by a provider that offers a profit-sharing agreement to the operator. In another example, a third party may increase the weighting of incentives that are directed to improve engagement in an online user network, such as accruing loyalty points or notoriety points with respect to the user network or correlating to engagement upon the user network. Hierarchical sorting 317 may be dynamically adjusted in response to the incentives available in incentive data 315. Hierarchical sorting 317 may be dynamically adjusted by authorized parties, such as users, providers, operators, or third parties providing incentives. Some embodiments may comprise combination weighting of hierarchical sorting 317 that accounts for one or more of the above examples, or other weighting schema, without deviating from the teachings disclosed herein.

After the hierarchical sorting 317 of recommended solutions 313 is completed, a favored solution 321, having the highest weighting according to the weighted hierarchy, may be available for presentation for a user.

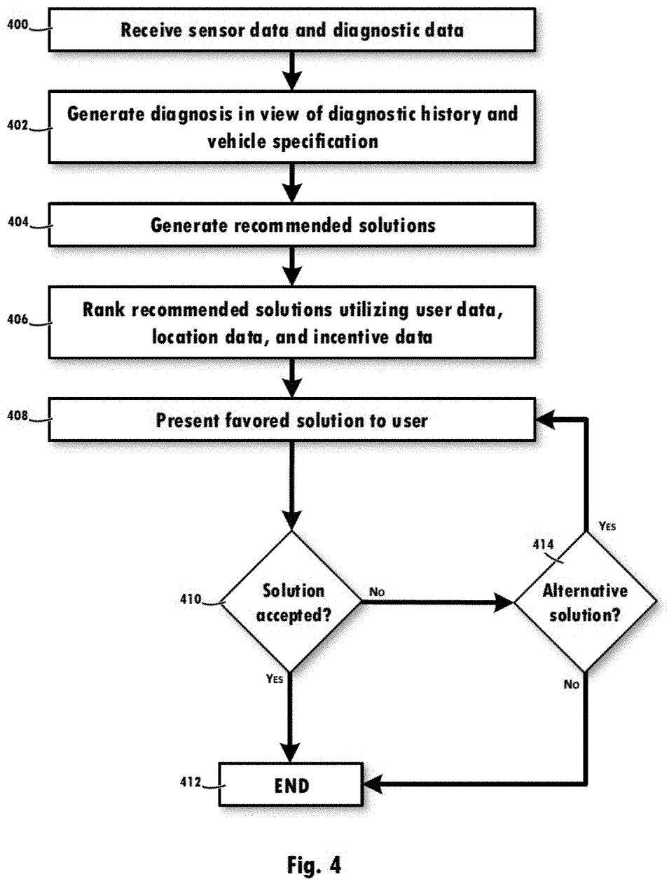

FIG. 4 is a flowchart illustrating a method of utilizing an incentivized diagnostic system, such as incentivized diagnostic system 200 (see FIG. 2), to find a recommended solution associated with an incentive to a user seeking to rectify a vehicle diagnosis. The method begins with the collection of sensor data and diagnostic data at step 400. After the data is collected, a diagnosis generated in response to the collected data and in view of vehicle data indicating the specifications of the vehicle at step 402. In response to the generated diagnosis, a number of recommended solutions are generated in step 404.

At step 406, the number of recommended solutions are ranked utilizing user data, location data, and incentive data associated with at least one of the recommended solutions. In the depicted embodiment, the ranking may be achieved using a hierarchical sorting, such as hierarchical sorting 317 (see FIG. 3), but other embodiments may comprise other ranking schema without deviating from the teachings disclosed herein.

After the recommended solutions are ranked, the highest-ranked solution and an associated incentive is presented to the user as a favored solution at step 408. The method proceeds to step 410 and the user responds by choosing to select the favored solution or not. If the user chooses the favored solution, the method may end at step 412. If the user does not choose the favored solution, the method proceeds to step 414, where it is determined if an alternative solution is available. In some embodiments, the alternative solution may be the favored solution presented with a different associated incentive. If an alternative solution is available, the method returns to step 408, presenting the alternative solution to the user. This cycle between steps 408, 410 and 414 may be iterated until the user selects a presented solution, or no further solutions are available for presentation. If no alternative solution is available at step 414, the method proceeds to step 412 and ends without a solution selected by the user.

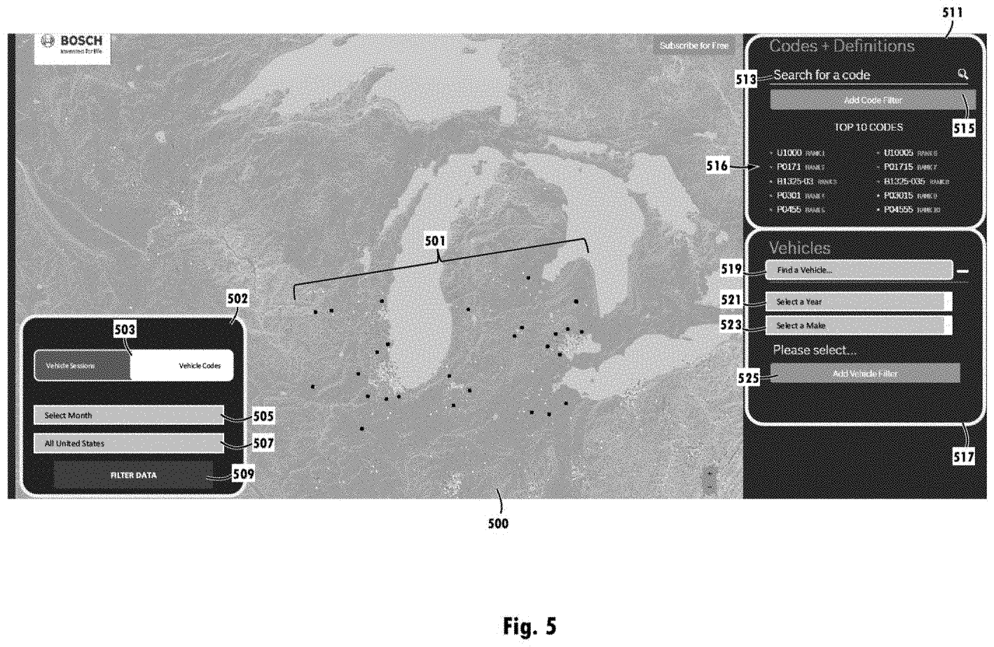

FIG. 5 is an illustration of a visual interface of an incentivized diagnostic system. The visual interface comprises a map view 500 of data, presenting a number of display points 501. Display points 501 correspond to data point within a set of data accessible to the incentivized diagnostic system. Display points 501 may be associated with a location datum within location data to be properly displayed upon map view 500. Display points 501 may represent user data, vehicle data, user data, diagnostic data, commerce data, cloud data, data describing current or previous diagnostic or repair sessions, or any other data accessible by the incentivized diagnostic system without deviating from the teachings disclosed herein. In some embodiments, display points 501 representing multiple types of data may be overlaid onto the same configuration of map view 500. In some embodiments, data may be displayed upon map view 500 utilizing other data display techniques, such as heat maps, concentration zones, behavioral trends, or any other map-centric data display known to one of ordinary skill in the art without deviating from the teachings disclosed herein.

In the depicted embodiment, map view 500 further comprises a windowing pane 502, providing a visual interface to control certain data filters useful in controlling the display of display points 501. Windowing pane 502 may be operable to provide a user with a selective view of the data displayed upon map view 500. The selective view of data may be useful in determining a likely diagnosis or favored solution based upon correlation to trends within the accessed data. Windowing pane 502 comprises a data-type toggle 503, operable to select one or more data types to be displayed upon map view 500. In the depicted embodiment, data-type toggle 503 is configured to display vehicle code data corresponding to instances reported to the incentivized diagnostic system of particular DTCs. Thus, in the depicted embodiment, display points 501 may correspond to reported instances of one or more DTCs at the locations associated with each report. Other embodiments may comprise other displays of different forms of display points 501 without deviating from the teachings disclosed herein. Other embodiments may permit selection of other data display formatting instead of or in addition to, display points 501 via data-type toggle 503 without deviating from the teachings disclosed herein.

Windowing pane 502 may additionally comprise a time filter 505 and a location filter 507, each of which may be used to window the available data to a particular time and location within the associated data for display. In the depicted embodiment, time filter 505 is operable to restrict the displayed data to a selected month of a particular year, but other embodiments may comprise other filters without deviating from the teachings disclosed herein. Examples of other times of time filters may comprise filters operable to restrict data to only a selected hour, a selected day, a selected week, a selected year, a range of hours, a range of days, a range of weeks, a range of months, or a range of years.

In the depicted embodiment, location filter 507 is operable to restrict the displayed data to that which is associated with locations within the boundaries of a selected state, but other embodiments may comprise other location filters without deviating from the teachings disclosed herein. Examples of other location filters may comprise filters operable to restrict data display to only a selected country, a selected time zone, a selected county, a selected city, or a selected postal zone. In some embodiments, other location filters may comprise filters operable to restrict data display to a selected group of countries, a selected group of states, a selected group of time zones, a selected group of counties, a selected group of cities, and a selected group of postal zones. In some embodiments, other location filters may comprise filters operable to restrict data display to within a radius surrounding a selected point upon the map or a selected arbitrary region within map view 500. In some embodiments, a user may assign and recall custom location filter definitions without deviating from the teachings disclosed herein.

In the depicted embodiment, windowing pane 502 may comprise a windowing execution control 509 operable to activate the selected filters controlled via windowing pane 502. Other embodiments may comprise individual execution controls for each filter or for combinations of filters without deviating from the teachings disclosed herein. Other embodiments may not comprise one or more of the controls depicted in windowing pane 502 without deviating from the teachings disclosed herein. Other embodiments may comprise a different combination of windowing filter controls within windowing pane 502 without deviating from the teachings disclosed herein. Other embodiments may comprise other controls instead of or in addition to the depicted controls of windowing pane 502 without deviating from the teachings disclosed herein. Some embodiments may not comprise some or all of the controls associated with windowing pane 502 without deviating from the teachings disclosed herein.

In the depicted embodiment, map view 500 may further comprise a code-filter pane 511. Code-filter pane 511 provides controls operable to filter the data displayed within map view 500 according to association with one or more diagnostic codes, such as a DTC. Code-filter pane 511 may comprise a code-search entry 511 operable to permit a user to search for a particular diagnostic code to be used as a filter parameter. In the depicted embodiment, a code-filter execution control 515 may be operable to activate the code filter specified in code-search entry 513. In some embodiments, code-filter execution control 515 may only be active if a valid code has been found using code-search entry 513 without deviating from the teachings disclosed herein. In the depicted embodiment, code-filter pane 511 may further comprise a popular code list 516. Popular code list 516 may provide a list of common diagnostic codes that are frequently searched, reported, or otherwise addressed by the incentivized diagnostic system. In the depicted embodiment, popular code list 516 may provide a user with a shortcut selection of a common diagnostic code, rather than requiring search via code-search entry 511. Some embodiments may comprise a different configuration of code-filter panel 511 without deviating from the teachings disclosed herein. Some embodiments may comprise other controls instead of or in addition to the controls depicted without deviating from the teachings disclosed herein. Some embodiments may not comprise some or all of the controls associated with code-filter pane 511 without deviating from the teachings disclosed herein.

In the depicted embodiment, map view 500 may further comprise a vehicle-filter pane 517. Vehicle-filter pane 517 provides controls operable to filter the data displayed within map view 500 according to association with one or more vehicle types. Vehicle-filter pane 517 may comprise a vehicle-search entry 519 operable to permit a user to search for a particular vehicle type to be used as a filter parameter. Vehicle-filter pane 517 may further comprise a year-selection 521 and a make selection 523 operable to quickly filter the vehicle types associated with a selected filter. In some embodiments may comprise additional vehicle filters, such as vehicle model, vehicle identification number (VIN), license plate number, vehicle registration number, insurance information, driver information, or owner information without deviating from the teachings disclosed herein. In some embodiments, vehicle-filter pane 517 may comprise additional filters directed to configuration details of a vehicle, such as engine type, number of wheels, vehicle class, associated vehicle components, associated electronic control unit (ECU) configurations, or any other configuration detail known to one of ordinary skill in the art without deviating from the teachings disclosed herein. In some embodiments, vehicle-filter pane 517 may comprise additional filters directed to vehicle history, such as odometer mileage, repair history, maintenance history, date of manufacturer, installation date of an aftermarket component, or any other vehicle history information known to one of ordinary skill in the art without deviating from the teachings disclosed herein. In the depicted embodiment, vehicle-filter pane 517 may comprise a vehicle-filter execution control 515 operable to activate the selected filters controlled via vehicle-filter pane 517. Other embodiments may comprise individual execution controls for each filter or for combinations of filters without deviating from the teachings disclosed herein. Other embodiments may not comprise one or more of the controls depicted in vehicle-filter pane 517 without deviating from the teachings disclosed herein. Other embodiments may comprise a different combination of filter controls within vehicle-filter pane 517 without deviating from the teachings disclosed herein. Other embodiments may comprise other controls instead of or in addition to the depicted controls of vehicle-filter pane 517 without deviating from the teachings disclosed herein. Some embodiments may not comprise some or all of the controls associated with vehicle-filter pane 517 without deviating from the teachings disclosed herein.

In some embodiments, the invention disclosed herein may be implemented in full or in part using a computer-readable medium having computer-executable instructions stored thereon that when read by a processor cause the processor to perform the functions disclosed herein. Computer-executable instructions may include instructions and data that cause a general-purpose computer, special purpose computer, or special-purpose processing device to perform a certain function or group of functions. Computer-executable instructions may also include program modules that are executed by computers in stand-alone or network environments. Program modules may include routines, programs, objects, components, or data structures that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Computer-readable media may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of utilizing a diagnostic device to assist a user associated with the diagnostic device in repairing a vehicle comprising:
obtaining diagnostic data through a vehicle diagnostic interface, the diagnostic data indicating a condition of the vehicle;
generating one or more recommended solutions in response to the diagnostic data;
selecting a favored solution from among the recommended solutions, the selection utilizing user data indicating preferences of the user, commerce data indicating status of providers of goods or services in a localized proximity to the diagnostic device, and incentive data indicating incentives associated with the providers, goods, or services; and
presenting the user with the favored solution and an incentive associated with the favored solution.

2. The method of claim 1, wherein the incentive is selected from the incentive data utilizing a hierarchical decision algorithm.

3. The method of claim 2, wherein user data further comprises user history data indicating past user interactions with the diagnostic device.

4. The method of claim 2, wherein the hierarchical decision algorithm is updated in response to a change in the commerce data.

5. The method of claim 1, wherein the incentive comprises a membership incentive associated with a user profile of the user of the diagnostic device.

6. The method of claim 5, wherein the membership incentive comprises a number of spendable points affiliated with a membership loyalty rewards program.

7. The method of claim 5, wherein the membership incentive comprises membership in a virtual community.

8. The method of claim 1, wherein the incentive comprises a discount coupon customized for the user of the diagnostic device.

9. The method of claim 8, wherein the terms of the discount coupon change based upon the amount of time that has passed since the incentive was first presented to the user.

10. The method of claim 1, wherein the incentive comprises an offer of technical support.

11. The method of claim 10, wherein the technical support comprises media content providing detailed instructions or educational material.

12. The method of claim 10, wherein the technical support comprises on-site assistance from a technician.

13. The method of claim 1, further comprising, after the obtaining diagnostic data step, a step of adding the diagnostic data to a data store comprising previously-obtained diagnostic data, and wherein the step of generating one or more favored solutions comprises utilizing the previously-obtained diagnostic data.

14. The method of claim 13, wherein the diagnostic device is a first diagnostic device and the previously-obtained diagnostic data comprises diagnostic data obtained using a second diagnostic device.

15. A vehicle diagnostic and incentive system comprising:
a diagnostic processor associated with a user of the system and operable for data communication with a number of sensors operable to generate diagnostic data indicating an operational condition of a vehicle;
a location sensor operable for data communication with the diagnostic processor and configured to generate location data indicating the location of at least one of the vehicle, the diagnostic processor, or the user;
a diagnostic-data store operable for data communication with the diagnostic processor and operable to store the diagnostic data;
a commerce-data store operable for data communication with the diagnostic processor and configured to store and communicate commerce data indicating status of providers of goods or services; and
a human-machine interface operable for data communication with the diagnostic processor,
wherein the diagnostic processor is operable to generate a number of solutions in response to the diagnostic data, select a favored solution from among the number of solutions based upon preferences of the user of the system and the commerce data, generate an incentive associated with the favored solution, and present the user with the favored solution and the associated incentive using the human-machine interface.

16. The system of claim 15, wherein the human-machine interface is embodied within one of a mobile computing device, a tablet computer, a smartphone, or a user console of the vehicle.

17. The system of claim 15, wherein the diagnostic processor is operable to update the generated incentive in response to the passage of a period of time since an initial presentation of the incentive.

18. The system of claim 15, further comprising a cloud-data source in data communication with the diagnostic processor, the cloud-data source being operable to store the diagnostic data and the diagnostic processor being operable to utilize the stored diagnostic data for the generation of a number of solutions

19. The system of claim 18, wherein the diagnostic processor is a first diagnostic processor, and the cloud-data source is in data communication with a second diagnostic processor associated with a second user of the system and the first diagnostic processor is operable to access diagnostic data provided by the second diagnostic processor.

20. The system of claim 15, wherein the diagnostic processor is operable to generate the incentive in response to a hierarchical decision algorithm.
